(19) United States
(12) Patent Application Publication
(10) Pub. No.: US 2009/0146617 A1
(43) Pub. Date: Jun. 11, 2009

(54) Power-generation control device for detecting abnormality in power generator

(75) Inventor: Ko Yoshida, Anjo-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/314,308

(22) Filed: Dec. 8, 2008

(30) Foreign Application Priority Data
Dec. 11, 2007 (JP) 2007-319634

(51) Int. Cl. H02K 11/00

(52) U.S. Cl. 322/99

(57) ABSTRACT

In a power-generation control device, a voltage regulating unit regulates an output voltage of a power generator to a preset target level. When at least one of a plurality of types of abnormalities occurs in the power generator, an abnormality detector detects the at least one of the plurality of types of abnormalities occurred in the power generator. The abnormality detector allows detection of the plurality of types of abnormalities that are possible to occur in the power generator. A transmitter creates an alarm signal to thereby transmit, to an external device, the alarm signal. The alarm signal includes information indicative of the at least one of the plurality of types of abnormalities detected by the abnormality detector.

### CROSS REFERENCE TO RELATED APPLICATIONS

This application is based on Japanese Patent Application No. 2007-319634 filed on Dec. 11, 2007. The descriptions of the Patent Application are all incorporated herein by reference.

### FIELD OF THE INVENTION

The present invention relates to control devices for controlling the output of a power generator, and more particularly, to such control devices capable of detecting abnormalities in the power generator.

### BACKGROUND OF THE INVENTION

Some of conventional charging systems for motor vehicles are designed to communicate, between a power-generation control device for a power generator and an ECU via a common communication line connected with them, a signal indicative of the power-generation state of the power generator and a signal for controlling the power-generation state thereof. An example of such charging systems is disclosed in U.S. Pat. No. 5,629,606 corresponding to Japanese Patent Publication No. 3531771.

The charging system disclosed in the Patent Publication is designed to detect whether the common communication line is disconnected with at least one of the power-generation control system and the ECU. The charging system disclosed in the Patent Publication however is not designed to send, to the ECU, a signal indicative of the details of the power-generation abnormal state of the power generator.

### SUMMARY OF THE INVENTION

There is a method for, under abnormal power-generator conditions, sending, from a power-generation control device to an ECU, an alarm signal with a low level that represents the exited state of a power generator.

However, the method cannot send, from the power-generation control device to the ECU, a signal indicative of what type of abnormalities, such as electrical abnormalities or mechanical abnormalities, occurs in the power generator. In other words, even if receiving the alarm signal, the ECU cannot distinguish what type of abnormalities occurs in the power generator.

For this reason, each time an abnormality occurs in the power generator, the ECU turns on a warning light mounted on a meter panel even if it is determined that there is no need to give an alarm according to the type of the abnormality occurred in the power generator.

For example, when a cable connecting between a sensing terminal (S terminal) of the power generator and a battery for sensing the terminal voltage of the battery is disconnected with the sensing terminal, such a cable-disconnection abnormality is required for the power-generation control device to the ECU, but not required for the ECU to turn on a warning light. This is because such an abnormality does not occur in the power generator itself so that the power generator can continuously generate power.

In particular, as motor vehicles designed to communicate between an ECU and a power-generation control device installed in them have been increased in recent years, the variety of functions required for power-generation control devices, such as an alarming function for giving an alarm when an abnormality occurs in the power generator have been increased. Thus, when an abnormality occurs in a power generator, it is desired for such power-generation control devices to send, to an ECU, a signal indicative of the details of the abnormal state of the power generator.

In view of the background, an object of at least one aspect of the present invention is to provide power-generation control devices capable of sending, when an abnormality occurs in a power generator, information indicative of the details of the abnormal state of the power generator without significantly changing their existing structures.

According to one aspect of the present invention, there is provided a power-generation control device for controlling a power generator for a vehicle. The power-generation control device includes a voltage regulating unit that regulates an output voltage of the vehicle power generator to a preset target level. The power-generation control device includes an abnormality detector configured to, when at least one of a plurality of types of abnormalities occurs in the power generator, detect the at least one of the plurality of types of abnormalities occurred in the power generator. The abnormality detector is configured to allow detection of the plurality of types of abnormalities that are possible to occur in the power generator. The power-generation control device includes a transmitter that creates an alarm signal to thereby transmit, to an external device, the alarm signal, the alarm signal including information indicative of the at least one of the plurality of types of abnormalities detected by the abnormality detector.

According to another aspect of the present invention, there is provided a power-generation control device for controlling a power generator for a vehicle. The power-generation control device includes a voltage regulating unit that regulates an output voltage of the power generator to a preset target level. The power-generation control device includes an abnormality detector configured to, when at least one of a plurality of types of abnormalities occurs in the power generator, detect the at least one of the plurality of types of abnormalities occurred in the power generator. The abnormality detector is configured to allow detection of the plurality of types of abnormalities that are possible to occur in the power generator. The power-generation control device includes a power-generation state signal transmitter configured to transmit, to an external device, a power-generation state signal with a train of repetitive pulses. The power-generation state signal represents a state of a power-generation of the power generator. The state of the power-generation of the power generator is associated with the output voltage of the power generator to be regulated by the voltage regulating unit. The power-generation state signal transmitter is also configured to create an alarm signal by modulating at least one parameter of the power-generation state signal to thereby transmit, to the external device, the alarm signal. The modulated at least one parameter of the alarm signal uniquely represents the at least one of the plurality of types of abnormalities occurred in the power generator and detected by the abnormality detector.

### BRIEF DESCRIPTION OF THE DRAWINGS

Other objects and aspects of the invention will become apparent from the following description of embodiments with reference to the accompanying drawings in which:

FIG. 1 is a circuit diagram schematically illustrating an example of the structure of an in-vehicle system including an alternator with a power-generation control device and an electronic control unit (ECU) according to an embodiment of the present invention;

FIG. 2A is a view schematically illustrating an example of the waveform of a power-generation state signal when no abnormalities occur in the alternator according to the embodiment;

FIG. 2B is a view schematically illustrating an example of the waveform of a first type of an alarm signal indicative of a mechanical abnormality occurred in the alternator according to the embodiment;

FIG. 2C is a view schematically illustrating an example of the waveform of a second type of the alarm signal indicative of an electrical abnormality occurred in the alternator according to the embodiment; and

FIG. 3 is a flowchart schematically illustrating operations of a control circuit of the power-generation control device according to the embodiment of the present invention.

### DETAILED DESCRIPTION OF EMBODIMENTS OF THE INVENTION

An embodiment of the present invention will be described hereinafter with reference to the accompanying drawings.

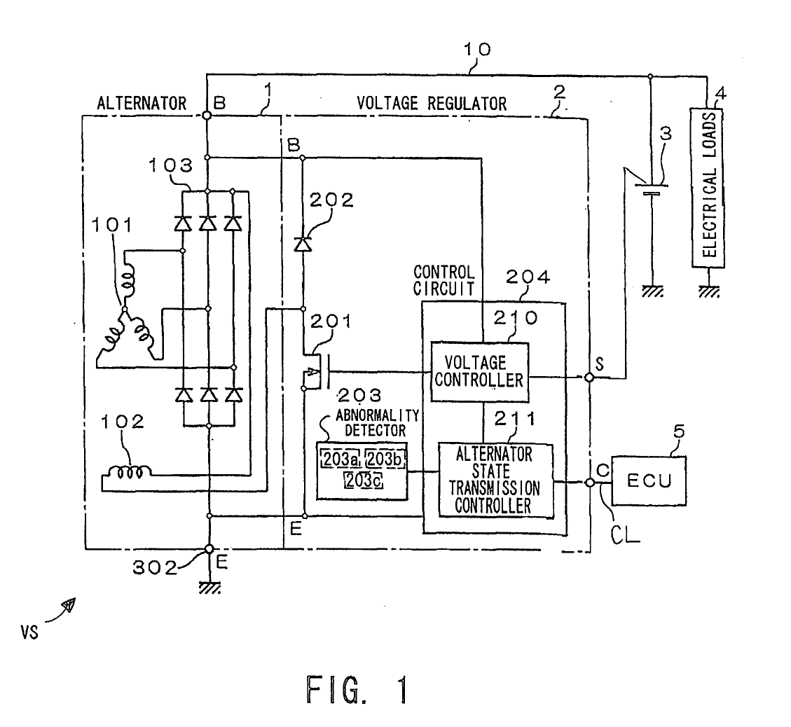

Referring to FIG. 1, there is provided an in-vehicle system VS installed in a motor vehicle according to an embodiment of the present invention.

The in-vehicle system VS includes an alternator 1 as an example of power-generators for motor vehicles. The alternator 1 is integrated with a voltage regulator 2 serving as a power-generation control device. The in-vehicle system VS also includes a battery 3, electrical loads 4, and a charging cable 10. The battery 3 has positive and negative terminals, the positive terminal of which is electrically connected with an output terminal B of the alternator 1 via the charging cable 10. The electrical loads 4 are also electrically connected with the output terminal B of the alternator 1 via the charging cable 10.

The in-vehicle system VS further includes an electronic control unit (ECU) 5 as an example of external devices; this ECU 5 is electrically connected with a control terminal C of the voltage regulator 2 via a communication line CL.

In addition, the voltage regulator 2 has a B terminal electrically connected with the output terminal B of the alternator 1, a S terminal electrically connected with the positive terminal of the battery 3, and an E terminal electrically connected with a ground terminal E of the alternator 1. For example, the E terminal of the voltage regulator 2 is electrically connected with the frame of the alternator 1.

The voltage regulator 2 works to regulate the voltage at the output terminal B of the alternator 1 to a preset target level of, for example, 14 V.

The alternator 1 is equipped with a field winding (exciting winding) 102 wound around a core of a rotor to create field poles (north and south poles) alternately arranged when energized. The rotor is, for example, coupled to a crankshaft of an engine through a belt to be rotatable therewith.

The alternator 1 is provided with three-phase stator windings 101 connected in, for example, star configuration and wound around a stator core that surrounds the rotor, and a rectifier 103 consisting of, for example, three pairs of positive (high-side) and negative (low-side) diodes connected in the form of a bridge. Specifically, the high-side and low-side diodes of each pair are connected in series at a connection point, and the connection points of the three-paired diodes are connected with lead wires of the three-phase stator windings 101, respectively.

The cathodes of the high-side diodes are commonly connected with the output terminal B of the alternator 1 and the B terminal of the voltage regulator 2, and the anodes of the low-side diodes are commonly connected with the ground terminal E of the alternator 1. One end of the exciting winding 102 is electrically connected with the cathodes of the high-side diodes, and the other end thereof is connected with the voltage regulator 2.

In the alternator 1, when the field winding 102 is energized while the rotor rotates, the rotating field winding 102 creates magnetic fluxes. The created magnetic fluxes magnetize the core to provide the field poles.

The rotation of the filed poles creates magnetic fluxes, and the created magnetic fluxes induce a three-phase AC voltage in the three-phase stator windings 101. The rectifier 103 full-wave rectifies the induced three-phase AC voltage induced in the stator windings 101 to a direct current (DC) voltage. The full-wave rectified DC voltage is output through the output terminal B so that the output DC voltage is supplied to the battery 3 to charge it, and to the electrical loads 4.

The output DC voltage of the alternator 1 depends on the number of rotation of the rotor and the amount of the field current to be supplied to the field winding 102.

Thus, the voltage regulator 2 is operative to control the field current to be supplied to the field winding 102.

Specifically, the voltage regulator 2 includes an N-channel MOSFET 201 as an example of power switching elements, a flywheel diode 202, an abnormality detector 203, and a control circuit 204.

The drain of the N-channel MOSFET 201 is electrically connected with the anode of the flywheel diode 202, and the source thereof is electrically connected with the E terminal of the voltage regulator 2. In other words, the N-channel MOSFET 201 is electrically connected with the flywheel diode 202 in series. The gate of the N-channel MOSFET 201 is electrically connected with the control circuit 204.

The flywheel diode 202 is connected at its cathode with the output terminal B of the alternator 1 via the B terminal of the voltage regulator 2 to be paralleled to the field winding 102.

Specifically, when the N-channel MOSFET 201 in on state, a field current flows through the filed winding 102 based on the voltage at the output terminal B of the alternator 1. In contrast, when the N-channel MOSFET 201 in off state, the field current continues to flow through the flywheel diode 202.

The abnormality detector 203 works to detect whether at least one of various types of abnormalities occurs in the alternator 1. For example, the abnormality detector 203 works to detect when either at least one of electrical abnormalities or at least one of mechanical abnormalities occurs in the alternator 1.

Specifically, the abnormality detector 203 is equipped with sensors 203a, 203b, 203c for measuring parameters indicative of whether electrical abnormalities and mechanical abnormalities occur in the alternator 1. For example, reference character 203a represents current sensors for measuring currents flowing through preset portions of the alternator 1 and indicative of whether electrical and/or mechanical abnormalities occur in the alternator 1. Reference character 203b represents temperature sensors for measuring temperatures of preset portions of the alternator 1 and indicative of whether electrical and/or mechanical abnormalities occur in the alternator 1. Reference character 203c represents vibration sensors for measuring vibrations of preset portions of the alternator 1 and indicative of whether electrical and/or mechanical abnormalities occur in the alternator 1.

Data measured by the sensors 203a to 203c of the abnormality detector 203 is configured to be outputted to the control circuit 204.

The control circuit 204 works to intermittently drive on and off the N-channel MOSFET 201 to thereby regulate the voltage at the output terminal of the alternator 1 to the preset target level. For example, the control circuit 204 includes a voltage controller 210 and an alternator-state transmission controller 211.

The voltage controller 210 is electrically connected with the source of the N-channel MOSFET 201 and operative to generate a drive signal, such as a PWM (Pulse Width Modulation) signal, consisting of the train of repetitive pulses each with a modulated pulse width according to a predetermined duty cycle and with a predetermined pulse-repetition frequency. The duty cycle (on duty) of the drive signal controls the flow of the field current through the N-channel MOSFET 201 to thereby regulate the voltage at the output terminal B of the alternator 1 corresponding to the terminal voltage of the battery 3 to the preset target level.

In the embodiment, for example, the preset target level is stored beforehand in the voltage controller 210, or has been sent from the ECU 5.

The voltage controller 210 is also operative to supply the drive signal to the gate of the N-channel MOSFET 201 to turn on and off the N-channel MOSFET 201 according to the duty cycle of the drive signal.

The alternator-state transmission controller 211 is electrically connected with the C terminal of the voltage regulator 2 and operative to transmit, via the communication line CL, a power-generation state signal and an alarm signal to the ECU 5.

The power-generation state signal for example corresponds to the drive signal to be inputted to the N-channel MOSFET 201 and represents the duty cycle for the N-channel MOSFET 201.

The alarm signal represents what type of abnormalities detected by the abnormality detector 203.

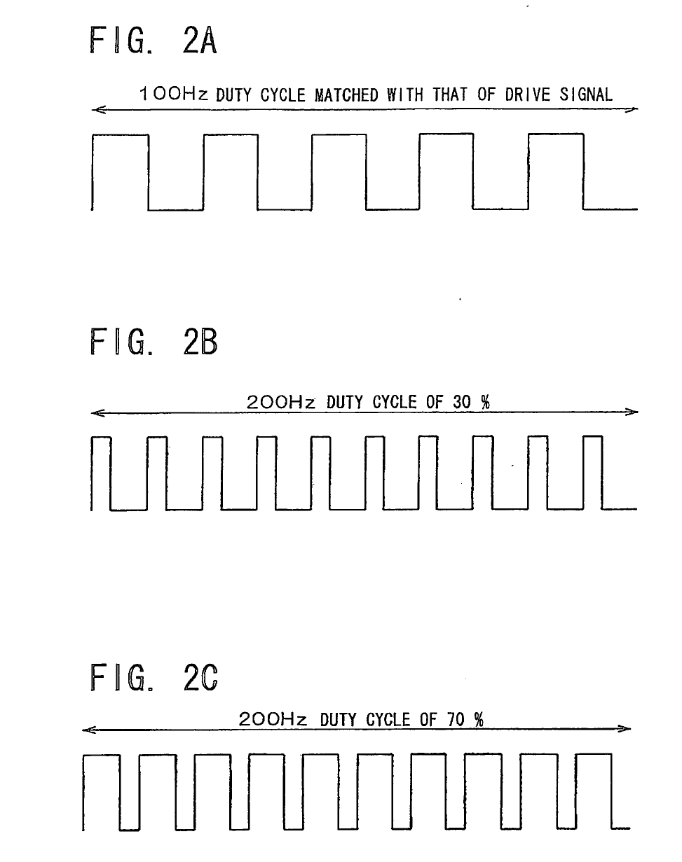

FIGS. 2A to 2C schematically illustrate schematic waveforms of the power-generation state signal and the alarm signal to be transmitted from the alternator-state transmission controller 211 to the ECU 5.

FIG. 2A illustrates an example of the waveform of the power-generation state signal when no abnormalities occur in the alternator 1. The alternator-state transmission controller 211 is configured to create the power-generation state signal having a predetermined duty cycle of, for example, 50% with a constant frequency of, for example, 100 Hz; this duty cycle is identical to that of the drive signal to be generated by the voltage controller 210. The duty cycle represents the ratio (%) of the on time of each pulse of the power-generation state signal (drive signal) to the period of the power-generation state signal.

FIG. 2B illustrates an example of the waveform of the first type of the alarm signal indicative of a mechanical abnormality occurred in the alternator 1. The alternator-state transmission controller 211 is configured to create the first type of the alarm signal having a predetermined duty cycle of, for example, 30% with a constant frequency of, for example, 200 Hz; these frequency and duty cycle are different from the frequency and duty cycle of the power-generation state signal, respectively.

FIG. 2C illustrates an example of the waveform of the second type of the alarm signal indicative of an electrical abnormality occurred in the alternator 1. The alternator-state transmission controller 211 is configured to create the second type of the alarm signal having a predetermined duty cycle of, for example, 70% with a constant frequency of, for example, 200 Hz; these frequency and duty cycle are different from the frequency and duty cycle of the power-generation state signal, respectively.

In other words, the alternator-state transmission controller 211 is configured to create the alarm signal of either the first type or second type by modulating some parameters, such as the duty cycle and the frequency, of the power-generation state signal illustrated in FIG. 2A; this power-generation state signal is a carrier signal before modulation.

Operations of the voltage regulator 2 according to the embodiment will be described hereinafter.

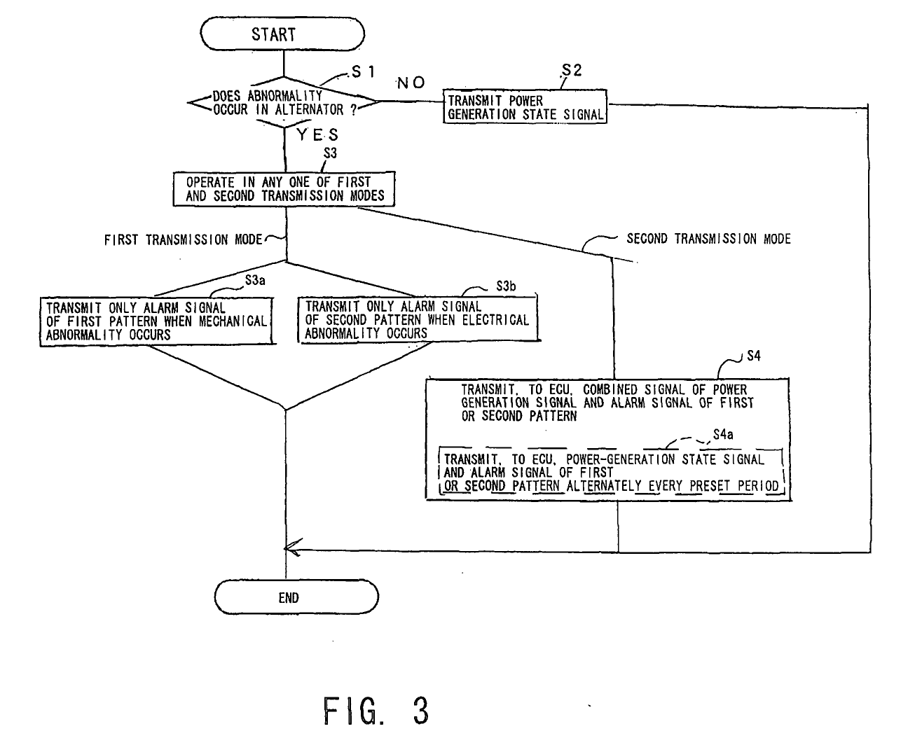

When it is determined that no abnormalities occur in the alternator 1 according to the data measured by the abnormality detector 203 (NO in step S1 of FIG. 3), the alternator-state transmission controller 211 creates the power-generation state signal matched with the drive signal to be supplied to the N-channel MOSFET 201, and transmits the power-generation state signal to the ECU 5 in step S2.

In contrast, when it is determined that an abnormality occurs in the alternator 1 according to the data measured by the abnormality detector 203 (YES in step S1), the alternator-state transmission controller 211 operates in any one of the following first and second transmission modes (steps S3 and S4).

In the first transmission mode, when it is determined that a mechanical abnormality occurs in the alternator 1 according to the data measured by the abnormality detector 203, the alternator-state transmission controller 211 creates the alarm signal of the first pattern and transmits, to the ECU 5, only the created alarm signal of the first pattern (see step S3a).

In contrast, in the first transmission mode, when it is determined that a mechanical abnormality occurs in the alternator 1 according to the data measured by the abnormality detector 203, the alternator-state transmission controller 211 creates the alarm signal of the second pattern and transmits, to the ECU 5, only the created alarm signal of the second pattern (see step S3b).

When receiving the alarm signal transmitted from the alternator-state transmission controller 211, the ECU 5 reliably and rapidly determines, based on the received alarm signal, the occurrence of an abnormality in the alternator 1 and distinguishes what type of abnormalities occur in the alternator 1.

In the second transmission mode, the alternator transmission controller 211 creates a combined signal of the power-generation state signal and the alarm signal of the first or second pattern and transmits, to the ECU 5, the created combined signal in step S4.

For example, in step S4, the alternator transmission controller 211 transmits as a combined signal to the ECU 5, the power-generation state signal and the alarm signal of the first or second pattern alternately every preset period, such as every four cycles in step S4a.

Specifically, in the second transmission mode, the alternator-state transmission controller 211 transmits, to the ECU 5, a combined signal such that:

the power-generation state signal and the alarm signal of the first pattern appear alternately every preset period when it is determined that a mechanical abnormality occurs in the alternator 1 according to the data measured by the abnormality detector 203; or

the power-generation state signal and the alarm signal of the second pattern appear alternately every preset period when it is determined that an electrical abnormality occurs in the alternator 1 according to the data measured by the abnormality detector 203.

When receiving the combined signal transmitted from the alternator-state transmission controller 211, the ECU 5 determines, based on the received alarm signal of the combined signal, the occurrence of an abnormality in the alternator 1 and distinguishes what type of abnormalities occur in the alternator 1.

Additionally, when receiving the combined signal, the ECU 5 determines, based on the received power-generation state signal, whether a normal power-generation state of the alternator 1 continuously maintained.

Note that, when to give a priority to the notice of the occurrence of an abnormality rather than the notice of the power-generation state signal, the alternator-state transmission controller 211 can increase, in the combined signal, the period during the transmission of the alarm signal rather than the period during the transmission of the power-generation state signal.

As set forth above, the voltage regulator 2 according to the embodiment makes possible to, when an abnormality occurs in the alternator 1, give information to the ECU 5, this information represents the details of the abnormal state of the alternator 1, such as the type of the abnormality occurred in the alternator 1.

Thus, the ECU 5 permits determination of whether there is the need to turn on a warning light mounted on the meter panel of the motor vehicle based on the information representing the type of the abnormality occurred in the alternator 1.

In addition, the alternator-state transmission controller 211 of the voltage regulator 2 is designed to transmit, to the ECU 5, the alarm signal via the existing communication terminal C and communication line CL. This allows the transmission of the details of the abnormal state of the alternator 1 to the ECU 5 without significantly changing the structure of the voltage regulator 2.

Specifically, the alternator-state transmission controller 211 of the voltage regulator 2 is designed to create the alarm signal by modulating the duty cycle (pulse width) and the frequency of the power-generation state signal to thereby transmit, to the ECU 5, the created alarm signal. This allows the use of the existing function of transmitting, to the ECU 5, the power-generation state signal in order to transmit the alarm signal thereto, making it possible to transmit the details of the abnormal state of the alternator 1 to the ECU 5 without significantly changing the structure of the voltage regulator 2.

Particularly, the alternator-state transmission controller 211 of the voltage regulator 2 is designed to selectively transmit, to the ECU 5, the power-generation state signal or the alarm signal of the first or second pattern. Specifically, the alternator-state transmission controller 211 is configured to use the existing function of transmitting the power-generation state signal to the ECU 5 to thereby transmit the alarm signal to the ECU 5. That is, the alternator-state transmission controller 211 to use the existing function of transmitting the power-generation state signal to the ECU 5 to thereby transmit both the alarm signal and the power-generation state signal to the ECU 5. This also allows the transmission of the details of the abnormal state of the alternator 1 to the ECU 5 while maintaining the change of the structure of the voltage regulator 2 to a minimum as required.

The present invention is not limited to the aforementioned embodiment and can be changed or modified within the scope thereof.

For example, in the aforementioned embodiment, the voltage regulator 2 is configured to:

detect a mechanical abnormality and an electrical abnormality occurred in the alternator 1;

create the alarm signal of the first type corresponding to the detected mechanical abnormality to thereby transmit it to the ECU 5; and

create the alarm signal of the second type corresponding to the detected electrical abnormality to thereby transmit it to the ECU 5.

The present invention is however not limited to the structure.

Specifically, the voltage regulator 2 can be configured to:

measure a plurality of types of abnormalities occurred in the alternator 1;

create an alarm signal for each of the detected types of abnormalities occurred in the alternator 1 by, for example, modulating at least one of the parameters of the power-generation state signal so as to change the created alarm signals with the differently modulated parameters; and

transmit, to the ECU 5, the created alarm signals for the respective types of abnormalities occurred in the alternator 1.

For example, the voltage regulator 2 can be configured to:

measure a plurality of types of abnormalities occurred in the alternator 1;

create an alarm signal for each of the detected types of abnormalities occurred in the alternator 1 by modulating the duty cycle of the parameters of the power-generation state signal so as to change the created alarm signals with the differently modulated duty cycles uniquely corresponding to the respective types of the abnormalities; and

transmit, to the ECU 5, the created alarm signals for the respective types of abnormalities occurred in the alternator 1.

As another example, the voltage regulator 2 can be configured to:

measure a plurality of types of abnormalities occurred in the alternator 1;

create an alarm signal for each of the detected types of abnormalities occurred in the alternator 1 by modulating the frequency of the parameters of the power-generation state signal so as to change the created alarm signals with the differently modulated frequencies uniquely corresponding to the respective types of abnormalities; and

transmit, to the ECU 5, the created alarm signals for the respective types of abnormalities occurred in the alternator 1.

While there has been described what is at present considered to be the embodiment and its modifications of the present invention, it will be understood that various modifications which are not described yet may be made therein, and it is intended to cover in the appended claims all such modifications as fall within the scope of the invention.

What is claimed is:

1. A power-generation control device for controlling a power generator for a vehicle, the power-generation control device comprising:
a voltage regulating unit that regulates an output voltage of the power generator to a preset target level;
an abnormality detector configured to, when at least one of a plurality of types of abnormalities occurs in the power generator, detect the at least one of the plurality of types of abnormalities occurred in the power generator, the abnormality detector being configured to allow detection of the plurality of types of abnormalities that are possible to occur in the power generator; and
a transmitter that creates an alarm signal to thereby transmit, to an external device, the alarm signal, the alarm signal including information indicative of the at least one of the plurality of types of abnormalities detected by the abnormality detector.

2. The power-generation control device according to claim 1, wherein the transmitter is configured to create the alarm signal by modulating at least one parameter of a pulsed carrier signal such that the modulated at least one parameter uniquely corresponds to the at least one of the plurality of types of abnormalities detected by the abnormality detector.

3. The power-generation control device according to claim 2, wherein the at least one parameter of the pulsed carrier signal is a duty cycle of the pulsed carrier signal.

4. The power-generation control device according to claim 3, wherein the transmitter is configured to allow creation of a plurality of the alarm signals respectively including a plurality of the duty cycles different from each other, the plurality of different duty cycles respectively corresponding to the plurality of types of abnormalities that are possible to occur in the power generator.

5. The power-generation control device according to claim 4, wherein the plurality of the alarm signals have a constant pulse-repetition frequency independently of the plurality of types of abnormalities that are possible to occur in the power generator.

6. The power-generation control device according to claim 2, wherein the at least one parameter of the pulsed carrier signal is a pulse-repetition frequency of the pulsed carrier signal, and the transmitter is configured to allow creation of a plurality of the alarm signals respectively including a plurality of the pulse-repetition frequencies different from each other, the plurality of different pulse-repetition frequencies respectively corresponding to the plurality of types of abnormalities that are possible to occur in the power generator.

7. The power-generation control device according to claim 1, wherein the transmitter is configured to selectively transmit any one of a power-generation state signal and the alarm signal, the power-generation state signal representing a state of a power-generation of the power generator, the state of the power-generation of the power generator being associated with the output voltage of the power generator to be regulated by the voltage regulating unit.

8. The power-generation control device according to claim 7, wherein the transmitter is configured to transmit, to the external device, the power-generation state signal when no types of abnormalities are detected by the abnormality detector, and to transmit, to the external device, the alarm signal when the at least one of the plurality of types of abnormalities occurred in the power generator is detected by the abnormality detector.

9. The power-generation control device according to claim 7, wherein the transmitter is configured to transmit, to the external device, the power-generation state signal when no types of abnormalities are detected by the abnormality detector, and to alternately transmit, to the external device, the alarm signal and the power-generation state signal when at least one of the plurality of types of abnormalities occurred in the power generator is detected by the abnormality detector.

10. The power-generation control device according to claim 9, wherein the transmitter is configured to transmit, to the external device, the alarm signal and the power-generation state signal alternately every preset period.

11. The power-generation control device according to claim 2, wherein the plurality of types of abnormalities that are possible to occur in the power generator include a mechanical abnormality therein, and the transmitter is configured to create the alarm signal by modulating the at least one parameter of the pulsed carrier signal such that the modulated at least one parameter corresponds to the mechanical abnormality in the power generator.

12. The power-generation control device according to claim 2, wherein the plurality of types of abnormalities that are possible to occur in the power generator include an electrical abnormality therein, and the transmitter is configured to create the alarm signal by modulating the at least one parameter of the pulsed carrier signal such that the modulated at least one parameter corresponds to the electrical abnormality in the power generator.

13. A power-generation control device for controlling a power generator for a vehicle, the power-generation control device comprising:
a voltage regulating unit that regulates an output voltage of the power generator to a preset target level;
an abnormality detector configured to, when at least one of a plurality of types of abnormalities occurs in the power generator, detect the at least one of the plurality of types of abnormalities occurred in the power generator, the abnormality detector being configured to allow detection of the plurality of types of abnormalities that are possible to occur in the power generator; and
a power-generation state signal transmitter configured to:
transmit, to an external device, a power-generation state signal with a train of repetitive pulses, the power-generation state signal representing a state of a power-generation of the power generator, the state of the power-generation of the power generator being associated with the output voltage of the power generator to be regulated by the voltage regulating unit; and
create an alarm signal by modulating at least one parameter of the power-generation state signal to thereby transmit, to the external device, the alarm signal, the modulated at least one parameter of the alarm signal uniquely representing the at least one of the plurality of types of abnormalities occurred in the power generator and detected by the abnormality detector.

14. The power-generation control device according to claim 13, wherein the at least one parameter of the power-generation state signal is a duty cycle of the power-generation state signal, and the power-generation state signal transmitter is configured to allow creation of a plurality of the alarm signals respectively including a plurality of the duty cycles different from each other, the plurality of different duty cycles respectively corresponding to the plurality of types of abnormalities that are possible to occur in the power generator.

15. The power-generation control device according to claim 14, wherein the plurality of the alarm signals have a constant pulse-repetition frequency independently of the plurality of types of abnormalities that are possible to occur in the power generator.

16. The power-generation control device according to claim 14, wherein the at least one parameter of the power-generation state signal is a pulse-repetition frequency of the power-generation state signal, and the power-generation state signal transmitter is configured to allow creation of a plurality of the alarm signals respectively including a plurality of the pulse-repetition frequencies different from each other, the plurality of different pulse-repetition frequencies respectively corresponding to the plurality of types of abnormalities that are possible to occur in the power generator.
